(19) United States
(12) Patent Application Publication
(10) Pub. No.: US 2017/0048383 A1
(43) Pub. Date: Feb. 16, 2017

(54) Method For Assisting Restricted Or Handicapped People, And Apparatuses For Performing Same

(71) Applicant: SIEMENS AKTIENGESELLSCHAFT, München (DE)

(72) Inventors: Marion Deveaud, Muenchen (DE); Thomas Henties, Feldkirchen-Westerham (DE); Gernot Hillier, Landshut (DE)

(73) Assignee: Siemens Aktiengesellschaft, Muenchen (DE)

(21) Appl. No.: 15/120,711

(22) PCT Filed: Nov. 11, 2014
(86) PCT No.: PCT/EP2014/074241

§ 371 Date: Aug. 22, 2016

(30) Foreign Application Priority Data
Feb. 27, 2014 (DE) 10 2014 203 586.4

(51) Int. Cl. H04M 1/725; B66B 13/14; B66B 25/00; H04W 4/00; B66B 1/46

(52) U.S. Cl. CPC H04M 1/72588; H04M 1/7253; H04W 4/008; B66B 1/468; B66B 25/003; B66B 13/146; B66B 2201/405; B66B 2201/4653; B66B 2201/4669

(57) ABSTRACT

A method is disclosed for assisting limited or handicapped persons wherein an infrastructure unit periodically transmits a signal with an auxiliary function offer from the infrastructure unit, wherein a mobile communication unit, which is situated close to the infrastructure unit, of the limited or handicapped person receives the signal with the auxiliary function offer and takes a use authorization certificate as a basis for forming a signal with an auxiliary function request and returns it to the infrastructure unit, and wherein the infrastructure unit provides at least one auxiliary function for the limited or handicapped person in accordance with the auxiliary function request. This may assist limited or handicapped persons with the auxiliary functions suitable for them in the region of infrastructure elements, e.g., escalators, revolving doors and lifts, in a simple and inexpensive manner, with misuse largely being precluded.

### CROSS-REFERENCE TO RELATED APPLICATIONS

This application is a U.S. National Stage Application of International Application No. PCT/EP2014/074241 filed Nov. 11, 2014, which designates the United States of America, and claims priority to DE Application No. 10 2014 203 586.4 filed Feb. 27, 2014, the contents of which are hereby incorporated by reference in their entirety.

### TECHNICAL FIELD

The invention relates to a method for assisting restricted or handicapped people in which these people are provided with special functions by relevant infrastructure elements.

### BACKGROUND

For people with restricted mobility or other forms of restriction, e.g. wheelchair users, but also for people with children or trolleys, many aids to passage or transport, such as escalators, conveyer belts, elevators, revolving doors, etc., for example, are unusable or usable only to a limited degree in the normal configuration, since the standard speeds are too high for them or activity cycles of these facilities are too short for them, for example.

In many cases, there are alternatives available, such as elevators instead of escalators, for example. These are frequently overloaded or associated with detours, however. In other cases, there are manual pushbutton switches available to reduce speeds, e.g. slowing down the revolving doors, or activating additional navigation aids, e.g. announcements for blind people. These can often be found or reached only with difficulty by the relevant group of people.

### SUMMARY

One embodiment provides a method for assisting restricted or handicapped people in the use of an infrastructure unit, wherein the infrastructure unit repeatedly transmits a signal with an assistance function offer from the infrastructure unit, wherein a mobile communication unit of the restricted or handicapped person, which mobile communication unit is close to the infrastructure unit, receives the signal with the assistance function offer and takes a use authorization certificate as a basis for forming a signal with an assistance function request and returns the latter signal to the infrastructure unit, and wherein the infrastructure unit provides at least one assistance function for the restricted or handicapped person in accordance with the assistance function request.

In one embodiment, the certificate is used only to establish a general use authorization, and all assistance functions of the infrastructure unit are activated.

In one embodiment, the certificate is used to establish a specific use authorization, and assistance functions of the infrastructure unit are activated depending on the restriction or handicap of the person.

In one embodiment, the presence of an assistance offer for the restricted or handicapped person is communicated to him audibly.

In one embodiment, the presence of an assistance function request by the restricted or handicapped person is communicated to other people close to the infrastructure unit.

In one embodiment, the assistance function offer involves extending a door opening time or reducing a speed of travel.

Another embodiment provides an infrastructure unit for performing the method as disclosed above, the infrastructure unit including a transmission unit that is set up such that a signal with an assistance function offer from the infrastructure unit is periodically transmittable, a reception unit that is set up such that a signal with an assistance function request is receivable, and a control unit that is set up such that at least one assistance function of the infrastructure unit is provided for the restricted or handicapped person in accordance with the assistance function request.

Another embodiment provides a mobile terminal for performing the method disclosed above, in the form of a universal mobile communication terminal having a near-field communication interface and a device for storing and executing an application program, wherein the application program prompts at least reception of the signal with the assistance function offer, checking of the use authorization certificate and formation and sending of the signal with the assistance function request.

### BRIEF DESCRIPTION OF THE DRAWINGS

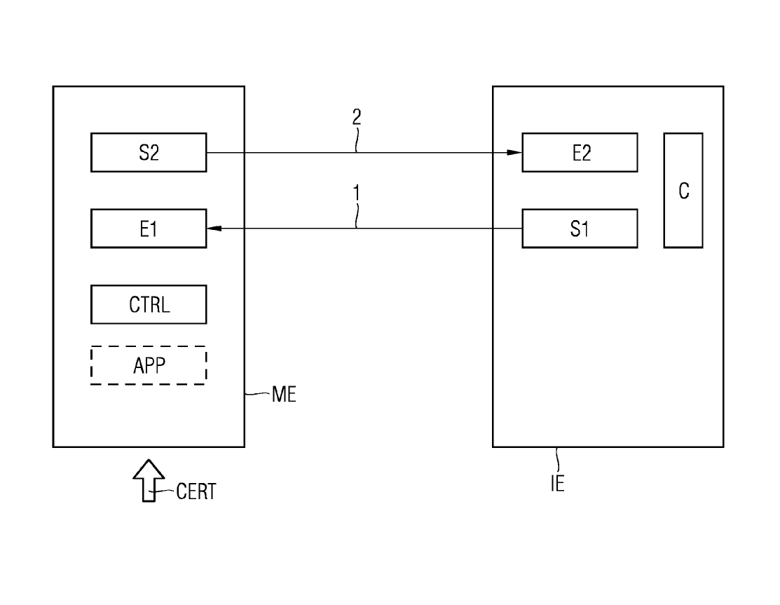

Example aspects of the invention are explained in more detail below with reference to the example embodiment shown in FIG. 1.

### DETAILED DESCRIPTION

Embodiments of the invention provide a way of assisting restricted or handicapped people in which the aforementioned disadvantages are avoided in a manner that is as simple to handle and inexpensive as possible.

Some embodiments provide a method for assisting restricted or handicapped people in which an infrastructure unit repeatedly transmits a signal with an assistance function offer from the infrastructure unit, in which a mobile communication unit of the restricted or handicapped person, which mobile communication unit is close to the infrastructure unit, receives the signal with the assistance function offer and takes a use authorization certificate as a basis for forming a signal with an assistance function request and returns the latter signal to the infrastructure unit, and in which the infrastructure unit provides at least one assistance function for the restricted or handicapped person in accordance with the assistance function request. This assists restricted or handicapped people in a simple an inexpensive manner by means of the assistance functions that are suitable for them in the region of infrastructure elements, such as escalators, revolving doors and elevators, for example, with misuse being largely precluded.

FIG. 1 shows a mobile terminal ME and an infrastructure element IE, wherein the mobile terminal ME has a reception unit E1, a transmission unit S2 and a control unit CTRL, wherein the infrastructure unit IE has a transmission unit S1, a reception unit E2 and a control unit C and wherein the transmission unit S1 is set up to send a signal 1 to the reception unit E1 when needed, and the transmission unit S2 is set up to send a signal 2 to the reception unit E1 likewise when needed. Furthermore, an optionally present application program APP and, to represent input of a certificate, an arrow with the label CERT are shown in the mobile terminal ME. The infrastructure unit IE uses the transmission device S1 to repeatedly, typically periodically, transmit a signal 1 that is received and recognized by the associated reception part E1 of the mobile terminal ME.

If the mobile terminal ME belongs to a restricted or handicapped person and if this person has a relevant certification CERT, then the transmission device S2 of the mobile terminal ME sends a corresponding signal 2 to the reception unit E1 of the infrastructure unit IE, whereupon the latter provides one or more relevant supplementary functionalities for the restricted or handicapped person.

The certificate CERT can either be used just to establish a general use authorization and to activate all assistance functions of the infrastructure unit IE or be used to establish a handicap-specific use authorization and to activate assistance functions of the infrastructure unit IE on a handicap-specific basis.

Optionally, the presence of an assistance offer for the restricted or handicapped person can be communicated, for example to a blind person, audibly via the mobile terminal ME or directly via the infrastructure element IE.

Optionally, the presence of an assistance function request by the restricted or handicapped person can be communicated by him to other people close to the infrastructure unit IE, that is to say in a radius of between 1 meter and several tens of meters.

On the basis of the signal 2, the infrastructure element IE can vary the functionality in accordance with the requirements. Examples may be: audible signals to the user, slowing down the speed of travel or extending door opening times, information from other passengers, etc.

Optionally, depending on the restriction or handicap, specific certificates CERT can be allocated or used and, in the relevant infrastructure unit, can prompt the relevant specific reaction for providing suitable functions. On the basis of the signal 2, the infrastructure element IE can vary or adapt the assistance functions in accordance with the requirements.

The mobile terminal ME may be embodied as what is known as a “standalone” terminal. Advantageously, this terminal can have a device for reading in a certificate, e.g. an electronic disability certificate.

However, the mobile terminal ME may optionally also be a user-programmable mobile terminal having wireless interfaces, e.g. a “smartphone”. In the case of a “smartphone”, the signalling 1, 2 and the check on the certificate CERT are then controlled or prompted by a relevant application program APP, for example.

The signals 1 and 2 are typically prompted by near-field communication, Bluetooth, IrDA, ZigBee, ultrasound, etc.

The infrastructure elements IE are typically escalators, revolving doors and elevators and, today, mostly already have, on account of various improvements, e.g. shutting down during non use in order to save power, speed regulation, accident prevention by means of sensors etc., complex electronic controllers with embedded systems that can be extended relatively easily and inexpensively in accordance with the invention.

What is claimed is:

1. A method for assisting restricted or handicapped people in the use of an infrastructure unit, the method comprising:
repeatedly transmitting, by the infrastructure unit, a signal with an assistance function offer from the infrastructure unit,
receiving, at a mobile communication unit of the restricted or handicapped person, which mobile communication unit is close to the infrastructure unit, the signal with the assistance function offer,
forming, by the mobile communication unit, signal with an assistance function request, based on a use authorization certificate,
communicating, by the mobile communication unit, the signal to the infrastructure unit, and
providing, by the infrastructure unit at least one assistance function for the restricted or handicapped person based on the assistance function request.

2. The method of claim 1, wherein the authorization certificate is used only to establish a general use authorization, and all assistance functions of the infrastructure unit are activated.

3. The method of claim 1, wherein the authorization certificate is used to establish a specific use authorization, and assistance functions of the infrastructure unit are activated depending on the restriction or handicap of the person.

4. The method of claim 1, wherein the presence of an assistance offer for the restricted or handicapped person is communicated to him audibly.

5. The method of claim 1, wherein the presence of an assistance function request by the restricted or handicapped person is communicated to other people close to the infrastructure unit.

6. The method of claim 1, wherein the assistance function offer involves extending a door opening time or reducing a speed of travel.

7. An infrastructure unit for performing method for assisting restricted or handicapped people in the use of an infrastructure unit, the infrastructure unit comprising:
a transmission unit configured for periodic transmission of a signal with an assistance function offer,
a reception unit configured to receive a signal with an assistance function request, and
a control unit configured to provide at least one assistance function of the infrastructure unit for the restricted or handicapped person in accordance with the received assistance function request.

8. A mobile terminal for performing a method for assisting restricted or handicapped people in the use of an infrastructure unit, wherein the infrastructure unit is embodied as a universal mobile communication terminal and comprises:
a near-field communication interface, and
a device comprising an application program stored in non-transitory computer-readable media and executable by a processor to perform a method including:
receiving, from the infrastructure unit, a signal including an assistance function offer,
checking for an authorization certificate,
forming a signal with an assistance function request, based at least on the authorization certificate,
communicating the signal to the infrastructure unit with an assistance function request to the infrastructure unit.

9. The mobile terminal of claim 8, wherein the authorization certificate is used only to establish a general use authorization, and all assistance functions of the infrastructure unit are activated.

10. The mobile terminal of claim 8, wherein the authorization certificate is used to establish a specific use authorization, and assistance functions of the infrastructure unit are activated depending on the restriction or handicap of the person.

11. The mobile terminal of claim 8, wherein the mobile terminal comprises an audible output device configure to audibly communicate the presence of the assistance function offer for the restricted or handicapped person.

12. The mobile terminal of claim 8, wherein the assistance function offer involves extending a door opening time or reducing a speed of travel.
